(19) United States
(12) Patent Application Publication
(10) Pub. No.: US 2025/0004789 A1
(43) Pub. Date: Jan. 2, 2025

(54) RESUMING SUSPENDED PROGRAM OPERATIONS IN A MEMORY DEVICE

(71) Applicant: Micron Technology, Inc., Boise, ID (US)

(72) Inventors: Keng Gee Ng, Singapore (SG); Mohammed Musaiyab Tarapati, Singapore (SG); Shyam Sunder Raghunathan, Singapore (SG)

(21) Appl. No.: 18/747,227

(22) Filed: Jun. 18, 2024

Related U.S. Application Data
(60) Provisional application No. 63/524,150, filed on Jun. 29, 2023.

(51) Int. Cl. G06F 9/4401

(52) U.S. Cl. CPC G06F 9/4418

(57) ABSTRACT

Control logic in a memory device initiates application of a program pulse on a memory array of a memory device as part of a program operation and determines whether a first request to suspend the program operation was received during the application of the program pulse. Responsive to determining that the first request to suspend the program operation was received during the application of the program pulse, the control logic sets a program suspend indicator to a suspend state. Responsive to completing application of the program pulse, the control logic initiates a program verify operation on the memory array, and responsive to completing the program verify operation, determines that the program suspend indicator is set to the suspend state and suspends the program operation.

### RELATED APPLICATIONS

This application claims the priority from U.S. Provisional Patent Application No. 63/524,150 filed Jun. 29, 2023, the entire contents of which are hereby incorporated by reference herein

### TECHNICAL FIELD

Embodiments of the disclosure relate generally to memory sub-systems, and more specifically, relate to resuming suspended program operations in a memory device of a memory sub-system.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various embodiments of the disclosure.

FIG. 1A illustrates an example computing system that includes a memory sub-system in accordance with some embodiments of the present disclosure.

FIG. 1B is a block diagram of a memory device in communication with a memory sub-system controller of a memory sub-system, in accordance with some embodiments of the present disclosure.

FIG. 2 is a schematic of portions of an array of memory cells as could be used in a memory of the type described with reference to FIG. 1B in accordance with some embodiments of the present disclosure.

FIG. 3 is a flow diagram of an example method of resuming suspended program operations in a memory device of a memory sub-system in accordance with some embodiments of the present disclosure.

FIG. 4 is a diagram illustrating the resuming of suspended program operations in a memory device of a memory sub-system in accordance with some embodiments of the present disclosure.

FIG. 5 is a block diagram of an example computer system in which embodiments of the present disclosure can operate.

### DETAILED DESCRIPTION

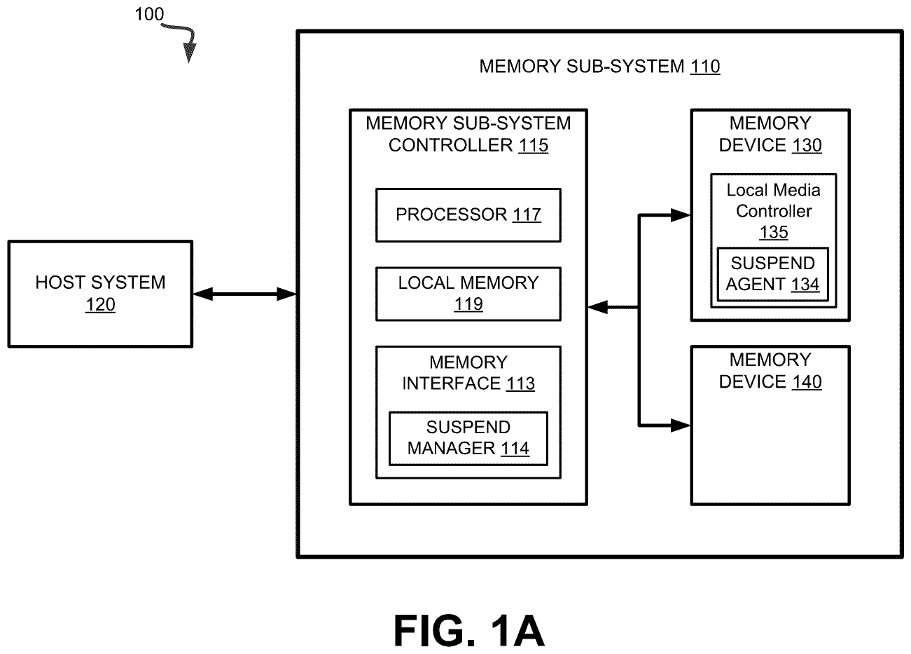

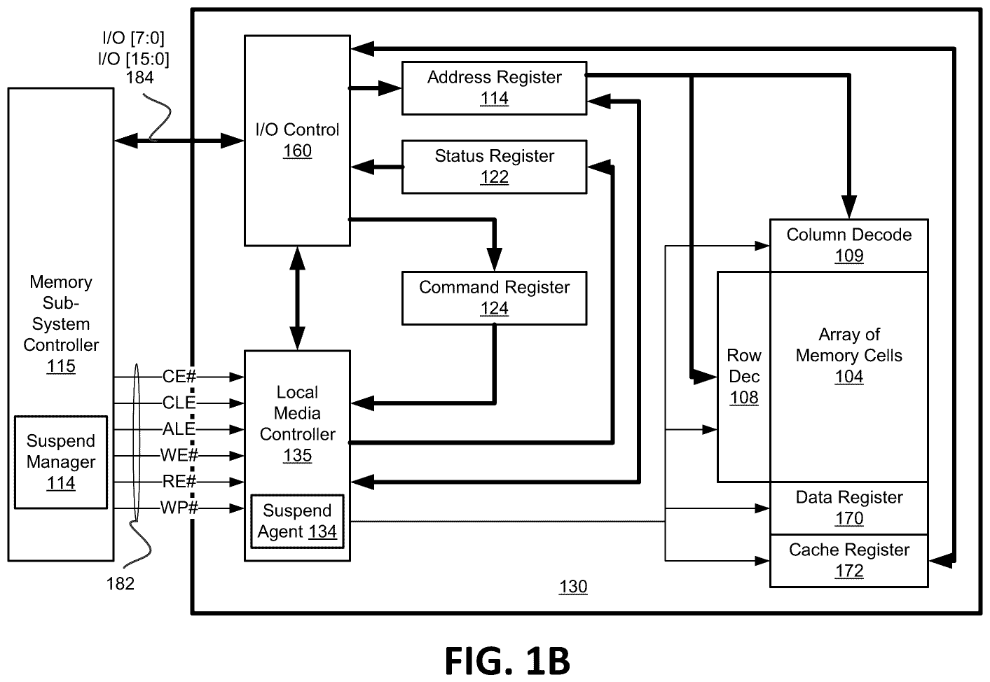

Aspects of the present disclosure are directed to resuming suspended program operations in a memory device of a memory sub-system. A memory sub-system can be a storage device, a memory module, or a hybrid of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. For example, NAND memory, such as 3D flash NAND memory, offers storage in the form of compact, high density configurations. A non-volatile memory device is a package of one or more dice, each including one or more planes. For some types of non-volatile memory devices (e.g., NAND memory), each plane includes a set of physical blocks. Each block includes a set of pages. Each page includes a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

A memory device can be made up of bits arranged in a two-dimensional or a three-dimensional grid. Memory cells are formed onto a silicon wafer in an array of columns (also hereinafter referred to as bitlines) and rows (also hereinafter referred to as wordlines). A wordline can refer to one or more rows of memory cells of a memory device that are used with one or more bitlines to generate the address of each of the memory cells. The intersection of a bitline and wordline constitutes the address of the memory cell. A block hereinafter refers to a unit of the memory device used to store data and can include a group of memory cells, a wordline group, a wordline, or individual memory cells. One or more blocks can be grouped together to form separate partitions (e.g., planes) of the memory device in order to allow concurrent operations to take place on each plane. The memory device can include circuitry that performs concurrent memory page accesses of two or more memory planes. For example, the memory device can include multiple access line driver circuits and power circuits that can be shared by the planes of the memory device to facilitate concurrent access of pages of two or more memory planes, including different page types. For ease of description, these circuits can be generally referred to as independent plane driver circuits. Depending on the storage architecture employed, data can be stored across the memory planes (i.e. in stripes). Accordingly, one request to read a segment of data (e.g., corresponding to one or more data addresses), can result in read operations performed on two or more of the memory planes of the memory device.

In certain memory sub-systems it is quite common to receive a request to perform a memory access operation, such as a program operation of data from a host system, and then to subsequently receive a request to perform another memory access operation, such as a read operation on that same data from the host system right away, possibly even before the program operation has been completed. Conventional memory sub-systems sometimes keep the data being programmed in controller memory (e.g., dynamic random access memory (DRAM)) while the underlying memory device (e.g., negative-and (NAND) type flash memory) of the memory sub-system is being programmed, and then flush the controller memory when the program operation is complete. As long as the programming time (i.e., the time associated with performing the program operation of the memory device) is relatively short, a controller memory of reasonable size can accommodate the program data. When the memory device uses certain types of memory cells, such as triple level cells (TLCs) or quad-level cells (QLCs), however, the programming times can increase significantly. As such, the command latency time associated with the subsequently received memory access commands is increased significantly. If a subsequent request to perform a read operation is received while the program operation is still ongoing, certain memory sub-systems must wait until the program operation is complete before performing the read operation on the memory device. This can lead to significant latency in responding to requests from the host system.

In order to reduce latency in mixed workloads (e.g., a combination of program operations and read operations, such as a program operation followed immediately by a read operation), certain memory sub-systems utilize a program suspend protocol to allow subsequently received memory access commands (e.g., read operations) to access a page of a memory device on which a program operation is currently being performed. The program suspend protocol can use the memory device to temporarily pause the program operation to allow access to the memory array. In particular, when the memory sub-system receives a request to perform a memory access operation on data stored in a page of the memory device while a program operation (e.g., a TLC program operation) is in progress, a suspend manager of the memory sub-system controller can issue a specific program suspend command which causes the memory device to enter a suspend state, during which the ongoing program operation is temporarily suspended (e.g., paused). These memory devices, and their associated suspend protocols, can permit certain types of operations (e.g., read operations), to be performed while the memory device is in the suspend state. Once completed, the memory device can return to a normal operating state and resume the paused program operation.

During the period of time when the memory device is in the suspend state, the memory cells that were partially programmed with data before the program operation was suspended can experience certain forms of charge loss, such as quick charge loss (QCL). Since the level of charge stored in those cells decreases, the cells may not pass a program verify operation performed when the program operation is resumed. The program verify operation can be performed to determine whether the memory cells have reached a target voltage level and whether additional programming is needed. For example, during the program verify operation the level of charge stored at the cell is read and compared to an expected charge level. Due to the charge loss experienced while the program operation is suspended, certain memory cells may have a level of charge that is below that expected charge level. Accordingly, the memory device may cause an additional programming pulse to be applied to those cells to increase the charge level. This programming pulse can include a normal programming pulse having a magnitude fixed according to certain trim settings of the memory device or can include a selective slow program convergence (SSPC) pulse where the bitline associated with the memory cell is selectively biased during application of the programming pulse in order to increase the amount of charge in the memory cell by a lesser amount. Such an SSPC approach can typically be used when the amount of charge in the memory cell has reached a pre-verify threshold voltage that is relatively close to the target voltage level. The charge loss during the period when the program operation is suspended can impact the amount of charge measured during this program verify operation and can lead to the memory cell being miscategorized. For example, the charge loss can cause the amount of charge in the memory cell to drop below the pre-verify threshold voltage level, and thus, a normal programming pulse may be applied when, when SSPC would have been more appropriate. The application of the normal programming pulse in this scenario could cause the amount of charge in the memory cell to exceed the expected charge level, thereby hurting a read window budget (RWB) for programming distributions in the memory device.

Certain memory devices attempt to address the charge loss and decreased read margins that result from repeatedly resuming suspended program operations by causing a negative voltage offset to be applied to the programming pulse when the program operations are resumed. This negative voltage offset reduces the magnitude of the programming pulse, which can reduce the programming voltage overshoot and associated margin loss. The amount of charge loss varies from cell to cell, however, and there are varying degrees of voltage overshoot on memory cells being programmed to different programming levels. Thus, a single negative voltage offset applied to memory cells being programmed to all different programming levels can be sub-optimal and ultimately increase the total number of programming pulses applied to the memory device, potentially eliminating any benefit in the read margins, especially in the erase distribution of memory cells associated with the selected wordline.

In addition, certain memory devices may impose a limit on the number of times that a given program operation can be suspended before it is completed. When a burst of read traffic is received, that suspend limit might be reached rather quickly. Then, the program operation cannot be suspended again for the remainder of its operation, and any additional read operations received, or even any system-initiated background operations, must be delayed until the program operation is completed. This so called “tail programming” hurts the quality of service (QOS) provided by the memory sub-system to the host system.

Aspects of the present disclosure address the above and other deficiencies by providing an advanced technique for resuming suspended program operations in a memory device in order to mitigate memory cell charge loss. In one embodiment, control logic on the memory device can implement a program suspend processing flow that delays a suspend action in response to a request to suspend the program operation until after a program pulse is applied and a corresponding program verify operation is performed. Since the result of the program verify operation is maintained during the time the operation is suspended, any charge loss (e.g., QCL) that occurs does not result in an additional programming pulse being applied to those cells and the charge level does not overshoot the target level. In addition, the program suspend processing flow further delays any subsequent suspend actions in response to additional requests to suspend the program operation received during the program verify operation. Instead, the suspend action can be delayed until after the next programming pulse is applied and a corresponding program verify operation is performed. This prevents a suspend loop from happening and ensures forward progress of the program operation.

Advantages of this approach include, but are not limited to, improved performance in the memory sub-system. In the manner described herein, the latency associated with completion of subsequently received memory access commands with lower operation times can be reduced as performance of those operations need not wait for completion of ongoing memory access operations with higher operation times. This suspend functionality can be implemented without increasing margin degradation for memory cells as charge loss during the suspend period can be either suppressed or replaced. In addition, by reducing the charge level overshoot, the program suspend functionality does not require a very high negative offset when the suspended program operation is resumed, thereby further improving the memory device performance (i.e., programming time) and the edge margins of the memory cell distributions. Accordingly, the overall quality of service level of the memory sub-system is improved without imposing significant penalties in performance or reliability.

FIG. 1A illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-system 110. FIG. 1A illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access the memory components (e.g., memory devices 130) when the memory sub-system 110 is coupled with the host system 120 by the PCIe interface. The physical host interface can provide an interface for passing control, address, data, and other signals between the memory sub-system 110 and the host system 120. FIG. 1A illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include negative-and (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), and quad-level cells (QLCs), can store multiple bits per cell. In some embodiments, each of the memory devices 130 can include one or more arrays of memory cells such as SLCs, MLCs, TLCs, QLCs, or any combination of such. In some embodiments, a particular memory device can include an SLC portion, and an MLC portion, a TLC portion, or a QLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor 117 (e.g., a processing device) configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1A has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, a memory device 130 is a managed memory device, which is a raw memory device 130 having control logic (e.g., local controller 135) on the die and a controller (e.g., memory sub-system controller 115) for media management within the same memory device package. An example of a managed memory device is a managed NAND (MNAND) device. Memory device 130, for example, can represent a single die having some control logic (e.g., local media controller 135) embodied thereon. In some embodiments, one or more components of memory sub-system 110 can be omitted.

In one embodiment, the memory sub-system 110 includes a memory interface component 113, which includes suspend manager 114. Memory interface component 113 is responsible for handling interactions of memory sub-system controller 115 with the memory devices of memory sub-system 110, such as memory device 130. For example, memory interface component 113 can send memory access commands corresponding to requests received from host system 120 to memory device 130, such as program commands, read commands, or other commands. In addition, memory interface component 113 can receive data from memory device 130, such as data retrieved in response to a read command or a confirmation that a program command was successfully performed. In some embodiments, the memory sub-system controller 115 includes at least a portion of the memory interface 113. For example, the memory sub-system controller 115 can include a processor 117 (e.g., a processing device) configured to execute instructions stored in local memory 119 for performing the operations described herein. In some embodiments, the memory interface component 113 is part of the host system 110, an application, or an operating system. In one embodiment, memory interface 113 includes suspend manager 114, among other sub-components. Suspend manager 114 can direct specific commands, including suspend and resume commands, to memory device 130 to manage collisions between different memory access operations. A collision can occur when a first memory access operation is being performed on cells of a certain data block, sub-block, and wordline of memory device 130 when a request to perform a second memory access operation on cells of the same data block, sub-block and wordline is received. In response to such a collision, suspend manager 114 can determine how to proceed. In one embodiment, suspend manager 114 can suspend the first memory access operation (e.g., a program operation) by issuing a designated suspend command to memory device 130 and then issuing a request to perform a second memory access operation (e.g., a read operation) while the first memory access operation is suspended. Further details with regards to the operations of suspend manager 114 are described below.

In one embodiment, memory device 130 includes a suspend agent 134 configured to carry out corresponding memory access operations, in response to receiving the memory access commands from suspend manager 114. In some embodiments, local media controller 135 includes at least a portion of suspend agent 134 and is configured to perform the functionality described herein. In some embodiment, suspend agent 134 is implemented on memory device 130 using firmware, hardware components, or a combination of the above. In one embodiment, suspend agent 134 initiates application of a program pulse on a memory array of memory device 130 as part of a program operation and determines whether a first request to suspend the program operation was received (e.g., from suspend manager 114) during the application of the program pulse. Responsive to determining that the first request to suspend the program operation was received during the application of the program pulse, suspend agent 134 sets a program suspend indicator to a suspend state. For example, suspend agent 134 may maintain the suspend indicator (e.g., a single bit) in memory device firmware, and set the indicator to a given value (e.g., a logic 1) to represent the suspend state and to another value (e.g., a logic 0) to represent a default “non-suspend” state. Responsive to completing application of the program pulse, suspend agent 134 initiates a program verify operation on the memory array, and responsive to completing the program verify operation, determines that the program suspend indicator is set to the suspend state and suspends the program operation. Thus, although the request to suspend the program operation was received during application of the program pulse, suspend agent 134 does not actually suspend the program operation until the corresponding program verify operation has been completed. Suspend agent 134 can track whether a request to suspend the program operation was received using the suspend indicator. Further details with regards to the operations of suspend agent 134 are described below.

FIG. 1B is a simplified block diagram of a first apparatus, in the form of a memory device 130, in communication with a second apparatus, in the form of a memory sub-system controller 115 of a memory sub-system (e.g., memory sub-system 110 of FIG. 1A), according to an embodiment. Some examples of electronic systems include personal computers, personal digital assistants (PDAs), digital cameras, digital media players, digital recorders, games, appliances, vehicles, wireless devices, mobile telephones and the like. The memory sub-system controller 115 (e.g., a controller external to the memory device 130), may be a memory controller or other external host device. In one embodiment, memory sub-system controller 115 includes suspend manager 114.

Memory device 130 includes an array of memory cells 104 logically arranged in rows and columns. Memory cells of a logical row are typically connected to the same access line (e.g., a wordline) while memory cells of a logical column are typically selectively connected to the same data line (e.g., a bit line). A single access line may be associated with more than one logical row of memory cells and a single data line may be associated with more than one logical column. Memory cells (not shown in FIG. 1B) of at least a portion of array of memory cells 104 are capable of being programmed to one of at least two target data states.

Row decode circuitry 108 and column decode circuitry 109 are provided to decode address signals. Address signals are received and decoded to access the array of memory cells 104. Memory device 130 also includes input/output (I/O) control circuitry 160 to manage input of commands, addresses and data to the memory device 130 as well as output of data and status information from the memory device 130. An address register 114 is in communication with I/O control circuitry 160 and row decode circuitry 108 and column decode circuitry 109 to latch the address signals prior to decoding. A command register 124 is in communication with I/O control circuitry 160 and local media controller 135 to latch incoming commands.

A controller (e.g., the local media controller 135 internal to the memory device 130) controls access to the array of memory cells 104 in response to the commands and generates status information for the external memory sub-system controller 115, i.e., the local media controller 135 is configured to perform access operations (e.g., read operations, programming operations and/or erase operations) on the array of memory cells 104. The local media controller 135 is in communication with row decode circuitry 108 and column decode circuitry 109 to control the row decode circuitry 108 and column decode circuitry 109 in response to the addresses. In one embodiment, local media controller 135 includes suspend agent 134.

The local media controller 135 is also in communication with a cache register 172. Cache register 172 latches data, either incoming or outgoing, as directed by the local media controller 135 to temporarily store data while the array of memory cells 104 is busy writing or reading, respectively, other data. During a program operation (e.g., write operation), data may be passed from the cache register 172 to the data register 170 for transfer to the array of memory cells 104; then new data may be latched in the cache register 172 from the I/O control circuitry 160. During a read operation, data may be passed from the cache register 172 to the I/O control circuitry 160 for output to the memory sub-system controller 115; then new data may be passed from the data register 170 to the cache register 172. The cache register 172 and/or the data register 170 may form (e.g., may form a portion of) a page buffer of the memory device 130. A page buffer may further include sensing devices (not shown in FIG. 1B) to sense a data state of a memory cell of the array of memory cells 104, e.g., by sensing a state of a data line connected to that memory cell. A status register 122 may be in communication with I/O control circuitry 160 and the local memory controller 135 to latch the status information for output to the memory sub-system controller 115.

Memory device 130 receives control signals at the memory sub-system controller 115 from the local media controller 135 over a control link 182. For example, the control signals can include a chip enable signal CE #, a command latch enable signal CLE, an address latch enable signal ALE, a write enable signal WE #, a read enable signal RE #, and a write protect signal WP #. Additional or alternative control signals (not shown) may be further received over control link 182 depending upon the nature of the memory device 130. In one embodiment, memory device 130 receives command signals (which represent commands), address signals (which represent addresses), and data signals (which represent data) from the memory sub-system controller 115 over a multiplexed input/output (I/O) bus 184 and outputs data to the memory sub-system controller 115 over I/O bus 184.

For example, the commands may be received over input/output (I/O) pins [7:0] of I/O bus 184 at I/O control circuitry 160 and may then be written into command register 124. The addresses may be received over input/output (I/O) pins [7:0] of I/O bus 184 at I/O control circuitry 160 and may then be written into address register 114. The data may be received over input/output (I/O) pins [7:0] for an 8-bit device or input/output (I/O) pins [15:0] for a 16-bit device at I/O control circuitry 160 and then may be written into cache register 172. The data may be subsequently written into data register 170 for programming the array of memory cells 104.

In an embodiment, cache register 172 may be omitted, and the data may be written directly into data register 170. Data may also be output over input/output (I/O) pins [7:0] for an 8-bit device or input/output (I/O) pins [15:0] for a 16-bit device. Although reference may be made to I/O pins, they may include any conductive node providing for electrical connection to the memory device 130 by an external device (e.g., the memory sub-system controller 115), such as conductive pads or conductive bumps as are commonly used.

It will be appreciated by those skilled in the art that additional circuitry and signals can be provided, and that the memory device 130 of FIG. 1B has been simplified. It should be recognized that the functionality of the various block components described with reference to FIG. 1B may not necessarily be segregated to distinct components or component portions of an integrated circuit device. For example, a single component or component portion of an integrated circuit device could be adapted to perform the functionality of more than one block component of FIG. 1B. Alternatively, one or more components or component portions of an integrated circuit device could be combined to perform the functionality of a single block component of FIG. 1B. Additionally, while specific I/O pins are described in accordance with popular conventions for receipt and output of the various signals, it is noted that other combinations or numbers of I/O pins (or other I/O node structures) may be used in the various embodiments.

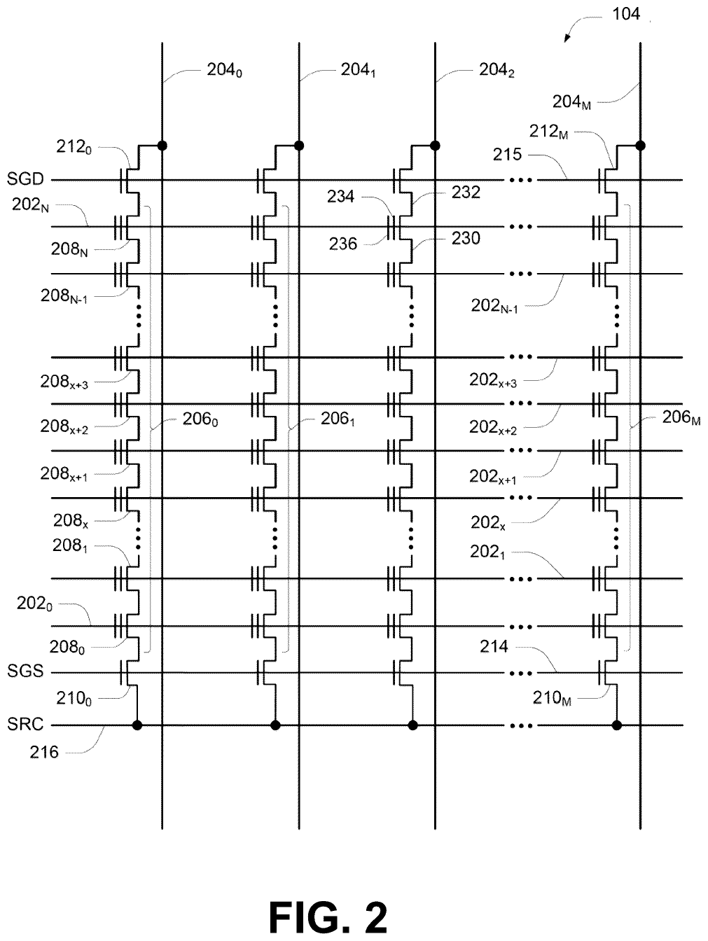

FIG. 2 is a schematic of portions of an array of memory cells 104, such as a NAND memory array, as could be used in a memory of the type described with reference to FIG. 1B according to an embodiment. Memory array 104 includes access lines, such as wordlines 202₀ to 202_{N}, and data lines, such as bit lines 204₀ to 204_{M}. The wordlines 202 can be connected to global access lines (e.g., global wordlines), not shown in FIG. 2, in a many-to-one relationship. For some embodiments, memory array 104 can be formed over a semiconductor that, for example, can be conductively doped to have a conductivity type, such as a p-type conductivity, e.g., to form a p-well, or an n-type conductivity, e.g., to form an n-well.

Memory array 104 can be arranged in rows (each corresponding to a wordline 202) and columns (each corresponding to a bit line 204). Each column can include a string of series-connected memory cells (e.g., non-volatile memory cells), such as one of NAND strings 206₀ to 206_{M}. Each NAND string 206 can be connected (e.g., selectively connected) to a common source (SRC) 216 and can include memory cells 208₀ to 208_{N}. The memory cells 208 can represent non-volatile memory cells for storage of data. The memory cells 208 of each NAND string 206 can be connected in series between a select gate 210 (e.g., a field-effect transistor), such as one of the select gates 210₀ to 210_{M} (e.g., that can be source select transistors, commonly referred to as select gate source), and a select gate 212 (e.g., a field-effect transistor), such as one of the select gates 212₀ to 212_{M} (e.g., that can be drain select transistors, commonly referred to as select gate drain). Select gates 210₀ to 210_{M} can be commonly connected to a select line 214, such as a source select line (SGS), and select gates 212₀ to 212_{M} can be commonly connected to a select line 215, such as a drain select line (SGD). Although depicted as traditional field-effect transistors, the select gates 210 and 212 can utilize a structure similar to (e.g., the same as) the memory cells 208. The select gates 210 and 212 can represent a number of select gates connected in series, with each select gate in series configured to receive a same or independent control signal.

A source of each select gate 210 can be connected to common source 216. The drain of each select gate 210 can be connected to a memory cell 208₀ of the corresponding NAND string 206. For example, the drain of select gate 210₀ can be connected to memory cell 208₀ of the corresponding NAND string 206₀. Therefore, each select gate 210 can be configured to selectively connect a corresponding NAND string 206 to the common source 216. A control gate of each select gate 210 can be connected to the select line 214.

The drain of each select gate 212 can be connected to the bit line 204 for the corresponding NAND string 206. For example, the drain of select gate 212₀ can be connected to the bit line 204₀ for the corresponding NAND string 206₀. The source of each select gate 212 can be connected to a memory cell 208_{N} of the corresponding NAND string 206. For example, the source of select gate 212₀ can be connected to memory cell 208_{N} of the corresponding NAND string 206₀. Therefore, each select gate 212 can be configured to selectively connect a corresponding NAND string 206 to the corresponding bit line 204. A control gate of each select gate 212 can be connected to select line 215.

The memory array 104 in FIG. 2 can be a quasi-two-dimensional memory array and can have a generally planar structure, e.g., where the common source 216, NAND strings 206 and bit lines 204 extend in substantially parallel planes. Alternatively, the memory array 104 in FIG. 2 can be a three-dimensional memory array, e.g., where NAND strings 206 can extend substantially perpendicular to a plane containing the common source 216 and to a plane containing the bit lines 204 that can be substantially parallel to the plane containing the common source 216.

Typical construction of memory cells 208 includes a data-storage structure 234 (e.g., a floating gate, charge trap, and the like) that can determine a data state of the memory cell (e.g., through changes in threshold voltage), and a control gate 236, as shown in FIG. 2. The data-storage structure 234 can include both conductive and dielectric structures while the control gate 236 is generally formed of one or more conductive materials. In some cases, memory cells 208 can further have a defined source/drain (e.g., source) 230 and a defined source/drain (e.g., drain) 232. The memory cells 208 have their control gates 236 connected to (and in some cases form) a wordline 202.

A column of the memory cells 208 can be a NAND string 206 or a number of NAND strings 206 selectively connected to a given bit line 204. A row of the memory cells 208 can be memory cells 208 commonly connected to a given wordline 202. A row of memory cells 208 can, but need not, include all the memory cells 208 commonly connected to a given wordline 202. Rows of the memory cells 208 can often be divided into one or more groups of physical pages of memory cells 208, and physical pages of the memory cells 208 often include every other memory cell 208 commonly connected to a given wordline 202. For example, the memory cells 208 commonly connected to wordline 202_{N} and selectively connected to even bit lines 204 (e.g., bit lines 204₀, 204₂, 204₄, etc.) can be one physical page of the memory cells 208 (e.g., even memory cells) while memory cells 208 commonly connected to wordline 202_{N} and selectively connected to odd bit lines 204 (e.g., bit lines 204₁, 204₃, 204₅, etc.) can be another physical page of the memory cells 208 (e.g., odd memory cells).

Although bit lines 204₃-204₅ are not explicitly depicted in FIG. 2, it is apparent from the figure that the bit lines 204 of the array of memory cells 104 can be numbered consecutively from bit line 204₀ to bit line 204_{M}. Other groupings of the memory cells 208 commonly connected to a given wordline 202 can also define a physical page of memory cells 208. For certain memory devices, all memory cells commonly connected to a given wordline can be deemed a physical page of memory cells. The portion of a physical page of memory cells (which, in some embodiments, could still be the entire row) that is read during a single read operation or programmed during a single programming operation (e.g., an upper or lower page of memory cells) can be deemed a logical page of memory cells. A block of memory cells can include those memory cells that are configured to be erased together, such as all memory cells connected to wordlines 202₀-202_{N} (e.g., all NAND strings 206 sharing common wordlines 202). Unless expressly distinguished, a reference to a page of memory cells herein refers to the memory cells of a logical page of memory cells. Although the example of FIG. 2 is discussed in conjunction with NAND flash, the embodiments and concepts described herein are not limited to a particular array architecture or structure, and can include other structures (e.g., SONOS, phase change, ferroelectric, etc.) and other architectures (e.g., AND arrays, NOR arrays, etc.).

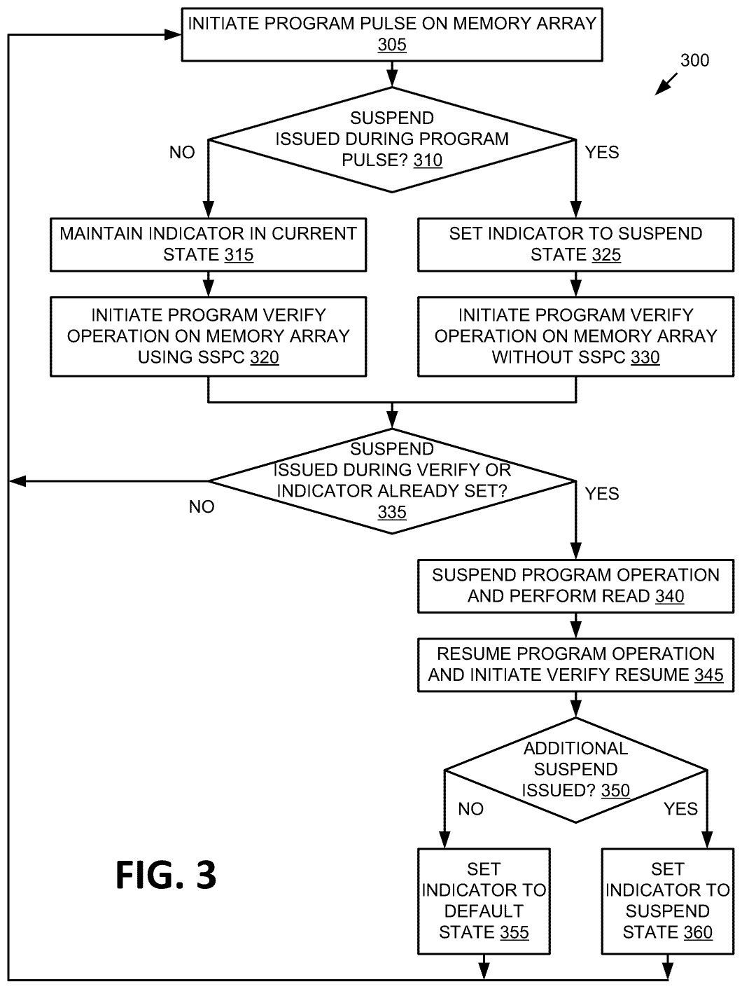

FIG. 3 is a flow diagram of an example method of resuming suspended program operations in a memory device of a memory sub-system in accordance with some embodiments of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by local media controller 135 and/or suspend agent 134 of FIG. 1A and FIG. 1B. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 305, a program pulse is applied. For example, control logic (e.g., local media controller 135 and/or suspend agent 134) can initiate application of a program pulse on a memory array, such as memory array 104, of a memory device, such as memory device 130, as part of a program operation. In one embodiment, to perform the program operation, the control logic can cause appropriate voltage signals to be applied to the corresponding wordlines of the memory array 104 of memory device 130. For example, the control logic can cause a program pulse to applied to a wordline associated with one or more memory cells to be programmed as part of the program operation. In one embodiment, the program operation can include multiple program pulses applied to one or more wordlines in sequence, and optionally including a program verify operation performed in between application of each of the program pulses.

At operation 310, a determination is made. For example, the control logic can determine whether a first request to suspend the program operation was received during the application of the program pulse. In one embodiment, a requestor, such as memory interface of 113 of memory sub-system controller 115, can send a request to suspend a memory access operation, such as a program operation, so that another memory access operation, such as a read operation or any other operation having higher priority, can be performed. In one embodiment, suspend manager 114 sends a request to suspend the memory access operation, such as a suspend command, to memory device 130, which is received by suspend agent 134.

At operation 315, a program suspend indicator is set. For example, responsive to determining that a request to suspend the program operation was not received during the application of the program pulse, the control logic can set the program suspend indicator to a default state. In one embodiment, suspend agent 134 maintains the program suspend indicator (e.g., a single bit) in memory device firmware, and sets the indicator to a given value (e.g., a logic 1) to represent the suspend state and to another value (e.g., a logic 0) to represent a default “non-suspend” state.

At operation 320, the programmed memory cells are verified. For example, responsive to completing application of the program pulse, the control logic can initiate a program verify operation on the memory array. In one embodiment, during the program verify operation, the control logic causes a read voltage to be applied to a selected wordline associated with the memory cell to be verified (i.e., a selected memory cell) to determine a level of charge stored at the selected memory cell to confirm whether the desired value was properly programmed. In one embodiment, the program verify operation uses a selective slow program convergence (SSPC) pulse. With SSPC, multiple pre-verify voltage levels can be calculated and the memory cells are programmed with incrementally increased programming pulses applied to associated wordlines. After each pulse, a program verify operation determines the threshold voltage for each cell. When the threshold voltage reaches a pre-verify threshold, only the bitline connected to that particular cell is biased with a fixed or static intermediate voltage that slows down the change in the threshold voltage of the cell. The other cells continue to be programmed at their normal pace. As the threshold voltage for each cell reaches the pre-verify level, it can be biased with the intermediate voltage. All of the bitlines can be biased with an inhibit voltage as their threshold voltages reach the verify voltage threshold.

At operation 325, a program suspend indicator is set. For example, responsive to determining that a request to suspend the program operation was received during the application of the program pulse, the control logic can set the program suspend indicator to a suspend state. Although the request to suspend was received during application of the program pulse, the program pulse is fully applied and the program operation is not immediately suspended. The program suspend indicator is set to track the receipt of the request to suspend the program operation, so that the program operation can be suspended at a later time, as will be described below.

At operation 330, the programmed memory cells are verified. For example, responsive to completing application of the program pulse, the control logic can initiate a program verify operation on the memory array. In one embodiment, during the program verify operation, the control logic causes a read voltage to be applied to a selected wordline associated with the memory cell to be verified (i.e., a selected memory cell) to determine a level of charge stored at the selected memory cell to confirm whether the desired value was properly programmed. In one embodiment, the program verify operation performed after a suspend was issued does not utilize a selective slow program convergence (SSPC) pulse. Since SSPC information is recollected during a verify resume operation once the suspended program operation is resumed, the program verify operation performed before the program operation is suspended can be performed without the SSPC pulse in order to save time and improve performance. Depending on the embodiment, rather than having a pre-verify threshold that is lower than the target voltage level, the control logic may only compare the measured voltage level to the target voltage level. In another embodiment, rather than having multiple pre-verify thresholds (i.e., as used for a dual SSPC approach), the control logic may utilize only a single pre-verify threshold (i.e., a single SSPC approach). Either option can result in a time savings that reduces the overall latency associated with performing the program operation.

At operation, 335, a determination is made. For example, responsive to completing the program verify operation at either operation 320 or operation 330, the control logic can determine whether a request to suspend the program operation was received during the program verify operation or whether the program suspend indicator was previously set to the suspend state and can then suspend the program operation. If no request to suspend the program operation was received during the program verify operation and the program suspend indicator was not previously set to the suspend state, processing can return to operation 305 for application of a subsequent programming pulse in the programming operation.

At operation 340, the program operation is suspended. For example, the control logic can cause the memory device 130 to enter the suspend state. In one embodiment, the program operation is suspended (i.e., paused, stopped, halted) during the suspend state. In one embodiment, suspend agent 134 stores progress information associated with the program operation in a page cache or other location in memory device 130. For example, suspend agent 134 can store data already programmed to memory array responsive to entering the suspend state, where such data can be used to resume the suspended program operation at a later time. In one embodiment, while the memory devices is in the suspend state, the control logic can receive, from a requestor (e.g., memory sub-system controller 115), a request to perform a memory access operation on the memory array 104 while the program operation is suspended. Depending on the embodiment, the memory access operation can include a read operation, a program operation, an erase operation, or other memory access operation. In one embodiment, to perform the memory access operation (e.g., a read operation) the control logic can cause appropriate voltage signals to be applied to the corresponding wordlines of the memory array 104 of memory device 130.

At operation 345, the program operation is resumed. For example, the processing logic can cause memory device 130 to exit the suspend state and resume the first memory access operation at a point where the first memory access operation left off using the progress information from the page cache. In one embodiment, suspend agent 134 can read the data stored in the page cache, which was previously written to the memory array, and compare that data to the data in a received resume command to determine where the memory access operation left off when suspended. Suspend agent 134 can thus resume programming the data for the first memory access operation to memory array from that point. As part of the resume operation, the control logic can initiate a verify resume operation on the memory array 104. In one embodiment, during the verify resume operation, the control logic causes a read voltage to be applied to a selected wordline associated with the memory cell to be verified (i.e., a selected memory cell) to determine the amount of charge stored at the selected memory cell to confirm whether the desired level was properly programmed.

At operation 350, a determination is made. For example, the control logic can determine whether a subsequent request to suspend the program operation was received (e.g., during the application of the program pulse, during the program verify operation, during the period of time when the program operation was suspended, or during the verify resume operation).

At operation 355, the program suspend indicator is set. For example, if no additional request to suspend the program operation was received, the control logic can set the program suspend indicator to a default (i.e., “non-suspend”) state.

At operation 360, the program suspend indicator is set. For example, if an additional request to suspend the program operation was received, the control logic can set the program suspend indicator to, or cause the program suspend indicator to remain in, the suspend state. After the program suspend indicator is set at either operation 355 or operation 360, processing can return to operation 305 for application of a subsequent programming pulse in the programming operation.

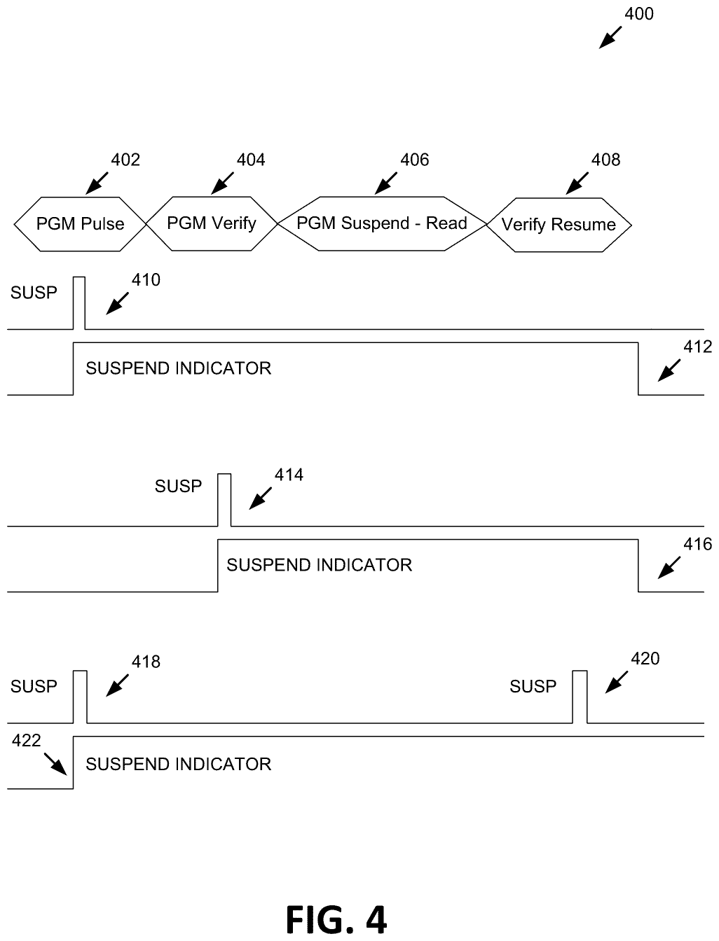

FIG. 4 is a diagram illustrating the resuming of suspended program operations in a memory device of a memory sub-system in accordance with some embodiments of the present disclosure. The processing flow for a program operation 400 includes application of a program (PGM) pulse 402 followed by a program verify operation 404. As will be described in more detail below, the program operation can be temporarily suspended for a period of time 406, during which another memory access operation (e.g., a read operation) can be performed. Upon completion of that other memory access operation, a verify resume operation 408 can be performed and the program operation can be resumed (e.g., by application of another program pulse (not shown)).

Depending on the embodiment, a request to suspend the program operation can be received at different points in time. For example, if a request 410 to suspend the program operation is received during application of the program pulse 402, the control logic can set the program suspend indicator 412 to a suspend state (e.g., a logic 1 or high value). Upon completion of the program verify operation 404, the control logic can check the status of the program suspend indicator 412, and upon determining that it is set to the suspend state, can suspend the program operation for the period 406 subsequent to completion of the program verify operation 404. Thus, responsive to a request to suspend the program operation being received during the application of the program pulse 402, the control logic can delay suspending the program operation until after the program verify operation 404 is complete. In one embodiment, the suspend indicator 412 remains in the suspend state until completion of the verify resume operation 408.

In another embodiment, if a request 414 to suspend the program operation is received during the program verify operation 404, the control logic can set the program suspend indicator 416 to a suspend state (e.g., a logic 1 or high value). Upon completion of the program verify operation 404, the control logic can check the status of the program suspend indicator 416, and upon determining that it is set to the suspend state, can suspend the program operation for the period 406 subsequent to completion of the program verify operation 404. Thus, responsive to a request to suspend the program operation being received during the program verify operation 404, the control logic can delay suspending the program operation until after the program verify operation 404 is complete. In one embodiment, the suspend indicator 416 remains in the suspend state until completion of the verify resume operation 408.

In another embodiment, if one request 418 to suspend the program operation is received during application of the program pulse 402, the control logic can set the program suspend indicator 422 to a suspend state (e.g., a logic 1 or high value). Upon completion of the program verify operation 404, the control logic can check the status of the program suspend indicator 422, and upon determining that it is set to the suspend state, can suspend the program operation for the period 406 subsequent to completion of the program verify operation 404. If, for example, another request 420 to suspend the program operation is received during the verify resume operation 408, the control logic can maintain the program suspend indicator 422 in the suspend state. The program suspend indicator 422 can remain in the suspend state until a subsequent program pulse is applied and a subsequent program verify operation is performed. Thus, responsive to a subsequent request 420 to suspend the program operation being received, the control logic can delay suspending the program operation until a subsequent program pulse is applied to the memory array and a subsequent program verify operation is performed. In one embodiment, the suspend indicator 422 remains in the suspend state until completion of a subsequent verify resume operation.

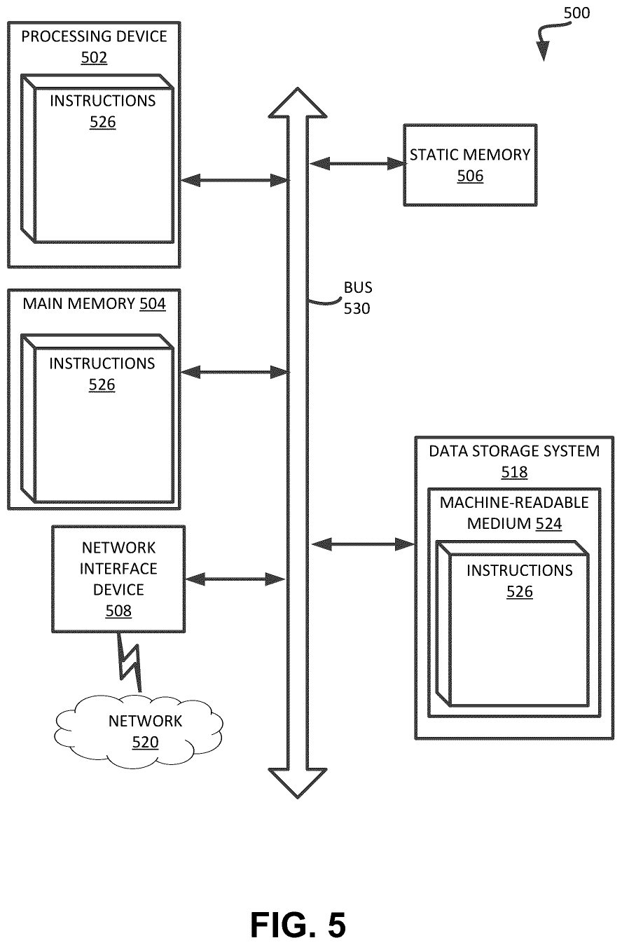

FIG. 5 illustrates an example machine of a computer system 500 within which a set of instructions, for causing the machine to perform any one or more of the methodologies discussed herein, can be executed. In some embodiments, the computer system 500 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the local media controller 135 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage system 518, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 can also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein. The computer system 500 can further include a network interface device 508 to communicate over the network 520.

The data storage system 518 can include a machine-readable storage medium 524 (also known as a computer-readable medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. The machine-readable storage medium 524, data storage system 518, and/or main memory 504 can correspond to the memory sub-system 110 of FIG. 1.

In one embodiment, the instructions 526 include instructions to implement functionality corresponding to the local media controller 135 of FIG. 1. While the machine-readable storage medium 524 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A memory device comprising:
a memory array; and
control logic, operatively coupled with the memory array, to perform operations comprising:
initiating application of a program pulse on the memory array as part of a program operation;
determining whether a first request to suspend the program operation was received during the application of the program pulse;
responsive to determining that the first request to suspend the program operation was received during the application of the program pulse, setting a program suspend indicator to a suspend state;
responsive to completing application of the program pulse, initiating a program verify operation on the memory array; and
responsive to completing the program verify operation, determining that the program suspend indicator is set to the suspend state and suspending the program operation.

2. The memory device of claim 1, wherein the control logic is to perform operations further comprising:
determining whether a second request to suspend the program operation was received during the program verify operation; and
responsive to determining that the second request to suspend the program operation was received during the program verify operation, setting the program suspend indicator to the suspend state.

3. The memory device of claim 1, wherein the program verify operation does not utilize a selective slow program convergence (SSPC) pulse.

4. The memory device of claim 1, wherein the control logic is to perform operations further comprising:
responsive to determining that the first request to suspend the program operation was not received during the application of the program pulse, setting the program suspend indicator to a default state; and
responsive to completing application of the program pulse, initiating a program verify operation on the memory array using a selective slow program convergence (SSPC) pulse.

5. The memory device of claim 1, wherein the control logic is to perform operations further comprising:
initiating a read operation on the memory array while the program operation is suspended; and
responsive to completing the read operation, initiating a verify resume operation and resuming the program operation.

6. The memory device of claim 5, wherein the control logic is to perform operations further comprising:
responsive to resuming the program operation, determining whether a third request to suspend the program operation was received during the verify resume operation; and
responsive to determining that the third request to suspend the program operation was received during the verify resume operation, setting the program suspend indicator to the suspend state and initiating application of a subsequent program pulse on the memory array as part of the program operation.

7. The memory device of claim 6, wherein the control logic is to perform operations further comprising:
responsive to determining that the third request to suspend the program operation was not received during the verify resume operation, setting the program suspend indicator to a default state.

8. A method comprising:
initiating application of a program pulse on a memory array of a memory device as part of a program operation;
determining whether a first request to suspend the program operation was received during the application of the program pulse;
responsive to determining that the first request to suspend the program operation was received during the application of the program pulse, setting a program suspend indicator to a suspend state;
responsive to completing application of the program pulse, initiating a program verify operation on the memory array; and
responsive to completing the program verify operation, determining that the program suspend indicator is set to the suspend state and suspending the program operation.

9. The method of claim 8, further comprising:
determining whether a second request to suspend the program operation was received during the program verify operation; and
responsive to determining that the second request to suspend the program operation was received during the program verify operation, setting the program suspend indicator to the suspend state.

10. The method of claim 8, wherein the program verify operation does not utilize a selective slow program convergence (SSPC) pulse.

11. The method of claim 8, further comprising:
responsive to determining that the first request to suspend the program operation was not received during the application of the program pulse, setting the program suspend indicator to a default state; and
responsive to completing application of the program pulse, initiating a program verify operation on the memory array using a selective slow program convergence (SSPC) pulse.

12. The method of claim 8, further comprising:
initiating a read operation on the memory array while the program operation is suspended; and
responsive to completing the read operation, initiating a verify resume operation and resuming the program operation.

13. The method of claim 12, further comprising:
responsive to resuming the program operation, determining whether a third request to suspend the program operation was received during the verify resume operation; and
responsive to determining that the third request to suspend the program operation was received during the verify resume operation, setting the program suspend indicator to the suspend state and initiating application of a subsequent program pulse on the memory array as part of the program operation.

14. The method of claim 13, further comprising:
responsive to determining that the third request to suspend the program operation was not received during the verify resume operation, setting the program suspend indicator to a default state.

15. A memory device comprising:
a memory array; and
control logic, operatively coupled with the memory array, to perform operations comprising:
initiating application of a program pulse on the memory array as part of a program operation;
initiating a program verify operation on the memory array as part of the program operation; and
responsive to a request to suspend the program operation being received during the application of the program pulse or during the program verify operation, delaying suspending the program operation until after the program verify operation is complete.

16. The memory device of claim 15, wherein the control logic is to perform operations further comprising:
implementing a program suspend indicator to track whether the request to suspend the program operation was received during the application of the program pulse or during the program verify operation.

17. The memory device of claim 16, wherein the suspend indicator is set to a first state to represent that the request to suspend the program operation was received and to a second state to represent that the request to suspend the program operation was not received.

18. The memory device of claim 15, wherein the program verify operation does not utilize a selective slow program convergence (SSPC) pulse.

19. The memory device of claim 15, wherein the control logic is to perform operations further comprising:
suspending the program operation after the program verify operation is complete;
initiating a read operation on the memory array while the program operation is suspended; and
responsive to completing the read operation, initiating a verify resume operation and resuming the program operation.

20. The memory device of claim 18, wherein the control logic is to perform operations further comprising:
responsive to resuming the program operation, determining whether a subsequent request to suspend the program operation was received; and
responsive to determining that the subsequent request to suspend the program operation was received, delaying suspending the program operation again until a subsequent program pulse is applied to the memory array and a subsequent program verify operation is performed.
